(19) United States
(12) Patent Application Publication
(10) Pub. No.: US 2018/0096641 A1
(43) Pub. Date: Apr. 5, 2018

(54) GAMMA IMPROVEMENT METHOD AND ASSOCIATED ELECTRONIC DEVICE

(71) Applicant: Himax Display, Inc., Tainan City (TW)

(72) Inventors: Kuo-Jung Lee, Tainan City (TW); Mao-Jung Chung, Tainan City (TW)

(21) Appl. No.: 15/281,116

(22) Filed: Sep. 30, 2016

(51) Int. Cl. G09G 3/20

(52) U.S. Cl. CPC G09G 3/2003; G09G 2300/0452; G09G 2320/0673; G09G 3/2074

(57) ABSTRACT

A Gamma improvement method includes: setting a group of primary colors to fit a first Gamma level, wherein the group of primary colors comprises red, green and blue; receiving a pixel value; and adjusting the pixel value to generate an adjusted pixel value; wherein a white component of the adjusted pixel value fits a second Gamma level according to a lookup table.

### BACKGROUND OF THE INVENTION

### 1. Field of the Invention

The present invention relates to an image processing method, and more particularly, to a Gamma improvement method and an associated electronic device.

### 2. Description of the Prior Art

Pixels used in Liquid Crystal on Silicon (LCOS) display applications are small, which causes a strong fringe effect between pixels. This phenomenon results in Gamma inconsistency of the primary colors, i.e. red, green and blue (RGB). Under this situation, when the white color in a pixel value is set to fit Gamma 2.2, the RGB in the pixel value corresponds to a sharp Gamma curve, which means the RGB luminance will easily undergo dramatic changes; the gray level will show this discontinuity. On the other hand, when the RGB in a pixel value is set to fit Gamma 2.2, the white color has a high risk of being overexposed. FIG. 1 is a diagram illustrating these situations, wherein sub-diagram (A) illustrates the white color being set to fit Gamma 2.2 and sub-diagram (B) illustrates the RGB being set to fit Gamma 2.2.

### SUMMARY OF THE INVENTION

One of the objectives of the present invention is to provide a Gamma improvement method and an associated electronic device to solve the abovementioned problem.

According to an embodiment of the present invention, a Gamma improvement method is disclosed, wherein the method comprises: setting a group of primary colors to fit a first Gamma level, wherein the group of primary colors comprises red, green and blue; receiving a pixel value; and adjusting the pixel value to generate an adjusted pixel value; wherein when the pixel value has a white color, the adjusted pixel value fits a second Gamma level.

According to an embodiment of the present invention, an electronic device is disclosed. The electronic device comprises: a storage device, arranged to store a program code; and a processor, arranged to execute the program code; wherein when loaded and executed by the processor, the program code instructs the processor to execute the following steps: setting a group of primary colors to fit a first Gamma level, wherein the group of primary colors comprises red, green and blue; receiving a pixel value; and adjusting the pixel value to generate an adjusted pixel value; wherein when the pixel value has a white color, the adjusted pixel value fits a second Gamma level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating characteristic curves of the white color and the RGB.

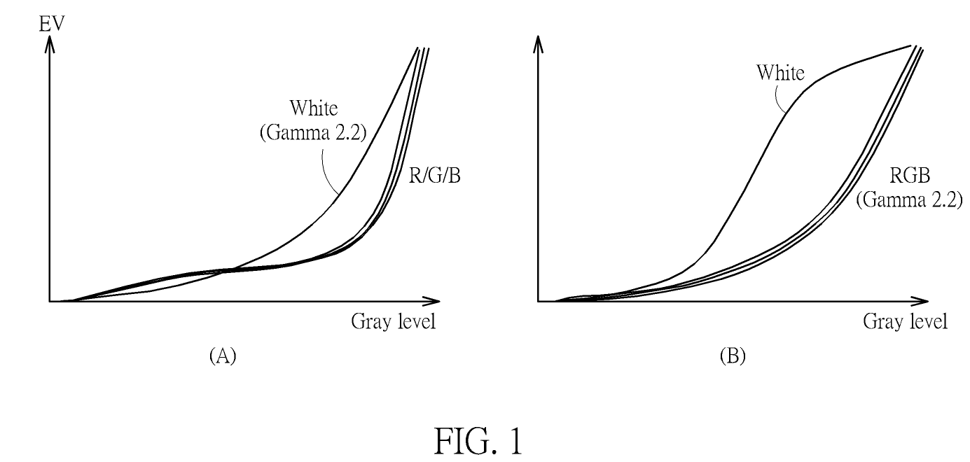

FIG. 2 is a diagram illustrating the process of making a lookup table by mapping the white color Gamma to fit Gamma 2.2 according to an embodiment of the present invention.

FIG. 3 is diagram illustrating a pixel value comprising a specific color after setting the primary colors to fit Gamma 2.2 according to an embodiment of the present invention.

FIG. 4 is a flowchart illustrating the Gamma improvement method according to an embodiment of the present invention.

FIG. 5 is a diagram illustrating the electronic device applying the Gamma improvement method of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

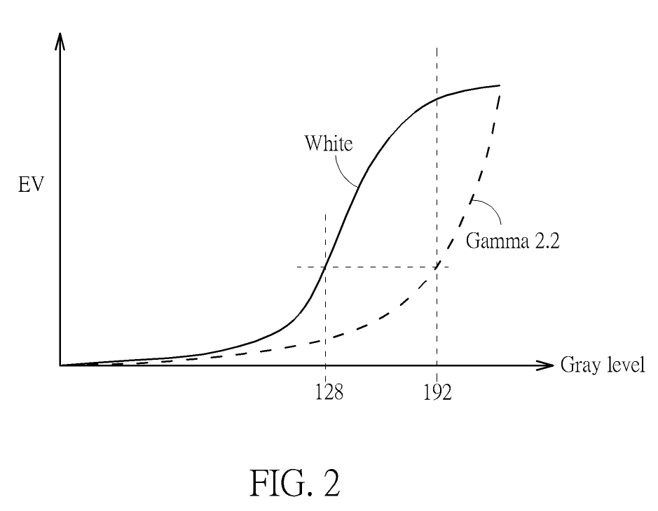

As mentioned above, when the primary colors, i.e. red, green, and blue, are set to fit Gamma 2.2, the white color will look oversaturated. FIG. 2 is a diagram illustrating a process of generating a lookup table by mapping the white color to fit Gamma 2.2 according to an embodiment of the present invention. After setting the primary colors to fit Gamma 2.2 by adjusting analog Gamma voltage, the white color has a Gamma curve (shown by the solid line in FIG. 2) which looks oversaturated. It can be easily observed that when the white color (the solid line) reaches gray level 128, it already has the same exposure value (EV) or luminance as when Gamma 2.2 (the dashed line) reaches the gray level 192. The present invention maps the gray level 192 to the gray level 128 for the white color to fit Gamma 2.2. Based on this operation, after mapping the gray levels 0-255 for the white color to fit Gamma 2.2, a lookup table is generated. By mapping a white component of a received pixel value to generate a new white component which fits Gamma 2.2 according to the lookup table, the received pixel value can be enhanced properly. It should be noted that the lookup table is generated in a manufacturing stage, i.e. before the electronic devices leave the factory. It should be noted that the gray levels illustrated for mapping are only examples, and not limitations of the present invention.

In this embodiment, the white component may indicate that a red component, a green component and a blue component of the pixel value have the same gray value, where the red component, the green component and the blue component respectively correspond to a red sub-pixel, a green sub-pixel and a blue sub-pixel of the pixel. Therefore, in the embodiment shown in FIG. 2, when the received pixel value is a white color having gray level 192 (i.e. the red component, the green component and the blue component all have gray values 192), the received pixel value is adjusted to have gray level 128 (i.e. the red component, the green component and the blue component all have gray values 128) to fit Gamma 2.2.

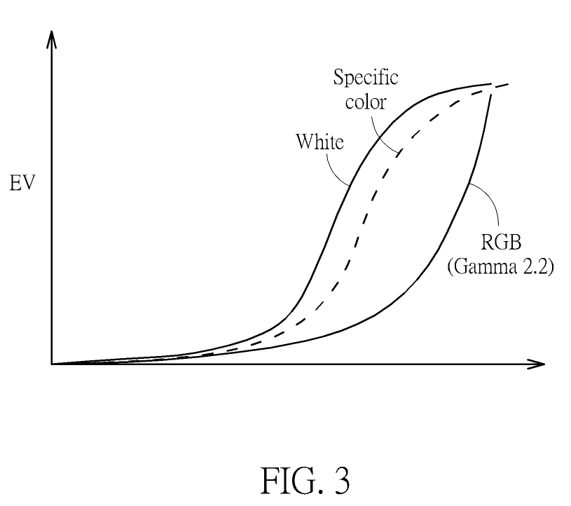

FIG. 3 is a diagram illustrating a received pixel value comprising a specific color (which is neither the white color nor any of the primary colors) after setting the primary colors to fit Gamma 2.2 according to an embodiment of the present invention. After the primary colors have been set to fit Gamma 2.2, the Gamma curve of the specific color of the pixel value (shown by the dotted line) is formed between the white color and the primary colors as shown in FIG. 3, due to the fact that every color is composed of the primary colors and the white color. In order to adjust the specific color of the pixel value to generate an adjusted pixel value, the present invention discloses the following formulae:

dR=abs(G−B)

dG=abs(B−R)

dB=abs(R−G)

dRGB=dR+dG+dB

RGB=R+G+B

Ratio=(dRGB/RGB)/2

R′=R*ratio+W′(R)*(1−ratio)

G′=G*ratio+W′(G)*(1−ratio)

B′=B*ratio+W′(B)*(1−ratio)

wherein R, G, B are the red component, the green component and the blue component of the pixel value, respectively, R′,G′, B′ are the red component, the green component and the blue component of the adjusted pixel value, respectively, ‘abs’ is the function of absolute value, and W′( ) is a function of mapping the white component (in which the red component, the blue component and the green component have the same value) of the pixel value according to the lookup table to generate a white component of the adjusted pixel value, wherein the new white component fits Gamma 2.2. From these formulae, the specific color is adjusted by a parameter ‘ratio’ indicative of the ratio between the primary colors and the white color of the specific color to enhance the luminance of the specific color.

The present invention discloses another formula for the specific color of the pixel value to achieve better saturation:

R′=R*ratio+W′(R)*{1−[K₁*(ratio)²+K₂*ratio]}

G′=G*ratio+W′(G)*{1−[K₁*(ratio)²+K₂*ratio]}

B′=B*ratio+W′(B)*{1−[K₁*(ratio)²+K₂*ratio]}

wherein K₁ and K₂ are constants, and in this embodiment, K₁ is −1 and K₂ is 2. By this formula, the specific color has better saturation. The value of the constants K₁ and K₂ are only for illustrative purposes, and are not a limitation of the present invention. In practice, the constants K₁ and K₂ are determined based on the designer's consideration which makes the algorithm more flexible.

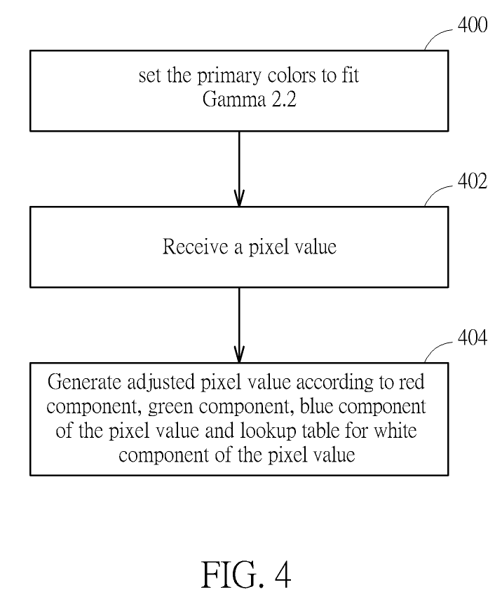

FIG. 4 is a flowchart illustrating the Gamma improvement method according to an embodiment of the present invention. Provided that the result is substantially the same, the steps are not required to be executed in the exact order shown in FIG. 4. The Gamma improvement method is summarized by the following steps.

Step 400: set the primary colors to fit Gamma 2.2.

Step 402: receive a pixel value.

Step 404: generate an adjusted pixel value according to a red component, a green component, and a blue component of the pixel value and a lookup table for a white component of the pixel value.

Those skilled in the art should readily understand the operation of the steps shown in FIG. 4 after reading the embodiments of FIG. 2 and FIG. 3. The detailed description is omitted here for brevity.

In the abovementioned embodiments, the white color and the primary colors are set to fit Gamma 2.2; however, this is only for illustrative purposes. In other embodiments, the white color can be mapped to fit a Gamma level, e.g. Gamma 2.0, while the primary colors are set to fit another Gamma level, e.g. Gamma 2.5, according to the designer's consideration.

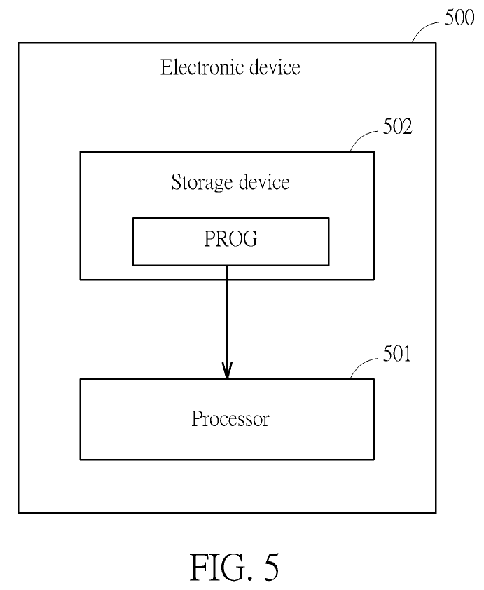

FIG. 5 is a diagram illustrating the electronic device 500 applying the Gamma improvement method of the present invention. As shown in FIG. 5, the electronic device 500 comprises a processor 501 and a storage device storing a program code PROG. When the program code PROG is loaded and executed by the processor 501, the calibrating flow shown in FIG. 4 is executed. The person skilled in the art should readily understand the operation of the processor 510 after reading the above paragraphs. The detailed description is therefore omitted here for brevity.

Briefly summarized, the present invention discloses a Gamma improvement method by setting the primary colors to fit Gamma 2.2, and utilizing a lookup table and the disclosed formulae to generate an adjusted pixel value for proper enhancement, wherein the lookup table is for compensating the white component.

Those skilled in the art will readily observe that numerous modifications and alterations of the device and method may be made while retaining the teachings of the invention. Accordingly, the above disclosure should be construed as limited only by the metes and bounds of the appended claims.

1. A Gamma improvement method, comprising:
setting a group of primary colors to fit a first Gamma level, wherein the group of primary colors comprises red, green and blue;
receiving a pixel value comprising a red component, a green component, a blue component and a first white component;
adjusting the pixel value to generate an adjusted pixel value; and
displaying the adjusted pixel value on a display;
wherein a second white component of the adjusted pixel value fits a second Gamma level according to a lookup table.

2. The Gamma improvement method of claim 1, further comprising:
generating the adjusted pixel value according to the red component, the green component and the blue component of the pixel value and the lookup table.

3. The Gamma improvement method of claim 2, wherein the step of generating the adjusted pixel value according to the red component, the green component and the blue component of the pixel value and the look-up table comprises:
calculating a ratio of primary colors according to the red component, the green component and the blue component of the pixel value; and
generating the adjusted pixel value according to the ratio of primary colors, the red component, the green component and the blue component of the pixel value, and the lookup table.

4. A Gamma improvement method, comprising:
setting a group of primary colors to fit a first Gamma level, wherein the group of primary colors comprises red, green and blue;
receiving a pixel value;
adjusting the pixel value to generate an adjusted pixel value according to a red component, a green component and a blue component of the pixel value and a lookup table; and
displaying the adjusted pixel value on a display;
wherein a white component of the adjusted pixel value fits a second Gamma level according to the lookup table;
wherein the step of generating the adjusted pixel value according to the red component, the green component and the blue component of the pixel value and the look-up table comprises:
calculating a ratio of primary colors according to the red component, the green component and the blue component of the pixel value; and
generating the adjusted pixel according to the ratio of primary colors, the red component, the green component and the blue component of the second pixel value, and the lookup table;
wherein the calculation of the ratio of primary colors is based on the following equations:
dR=abs(G−B);
dG=abs(B−R);
dB=abs(R−G);
dRGB=dR+dG+dB;
RGB=R+G+B;
Ratio=(dRGB/RGB)/2;
wherein ‘R’, ‘G’, ‘B’ are the red component, the green component and the blue component of the pixel value, respectively, and ‘abs’ is the function of absolute value.

5. The Gamma improvement method of claim 4, wherein the adjusted pixel value is calculated based on the following equations:
R′=R*ratio+W′(R)*(1−ratio);
G′=G*ratio+W′(G)*(1−ratio);
B′=B*ratio+W′(B)*(1−ratio);
wherein R′, G′, B′ are the red component, the green component and the blue component of the adjusted pixel value, respectively, and “W′( )” is a function of mapping the white component of the pixel value according to the lookup table to generate the white component of the adjusted pixel value, wherein the white component of the adjusted pixel value fits the second Gamma level.

6. The Gamma improvement method of claim 4, wherein the adjusted pixel value is calculated based on the following equations:
R′=R*ratio+W′(R)*{1−[K₁*(ratio)+K₂*ratio]};
G′=G*ratio+W′(G)*{1−[K₁*(ratio)+K₂*ratio]};
B′=B*ratio+W′(B)*{1−[K₁*(ratio)+K₂*ratio]};
wherein R′, G′, B′ are the red component, the green component and the blue component of the adjusted pixel value, respectively, K₁ and K₂ are constants, and “W′( )” is a function of mapping the white component of the pixel value according to the lookup table to generate the white component of the adjusted pixel value, wherein the white component of the adjusted pixel value fits the second Gamma level.

7. The Gamma improvement method of claim 6, wherein K₁ is −1 and K₂ is 2.

8. The Gamma improvement method of claim 1, wherein both the first Gamma level and the second Gamma level are Gamma 2.2.

9. An electronic device for applying a Gamma improvement method, comprising:
a storage device, arranged to store a program code; and
a processor, arranged to execute the program code;
wherein when loaded and executed by the processor, the program code instructs the processor to execute the following steps:
setting a group of primary colors to fit a first Gamma level, wherein the group of primary colors comprises red, green and blue;
receiving a pixel value comprising a red component, a green component, a blue component and a first white component;
adjusting the pixel value to generate an adjusted pixel value; and
displaying the adjusted value on a display;
wherein a second white component of the adjusted pixel value fits a second Gamma level according to a lookup table.

10. The electronic device of claim 9, wherein when loaded and executed by the processor, the program code instructs the processor to further execute the following steps:
generating the adjusted pixel value according to the red component, the green component and the blue component of the pixel value and the lookup table.

11. The electronic device of claim 10, wherein the step of generating the adjusted pixel value according to the red component, the green component and the blue component of the pixel value and the look-up table comprises:
calculating a ratio of primary colors according to the red component, the green component and the blue component of the pixel value; and
generating the adjusted pixel value according to the ratio of primary colors, the red component, the green component and the blue component of the pixel value, and the lookup table.

12. An electronic device for applying a Gamma improvement method, comprising:
a storage device, arranged to store a program code; and
a processor, arranged to execute the program code;
wherein when loaded and executed by the processor, the program code instructs the processor to execute the following steps:
setting a group of primary colors to fit a first Gamma level, wherein the group of primary colors comprises red, green and blue;
receiving a pixel value;
adjusting the pixel value to generate an adjusted pixel value according to a red component, a green component and a blue component of the pixel value and a lookup table; and
display the adjusted pixel value on a display;
wherein a white component of the adjusted pixel value fits a second Gamma level according to the lookup table;
wherein the step of generating the adjusted pixel value according to the red component, the green component and the blue component of the pixel value and the look-up table comprises:
calculating a ratio of primary colors according to the red component, the green component and the blue component of the pixel value; and
generating the adjusted pixel value according to the ratio of primary colors, the red component, the green component and the blue component of the pixel value, and the lookup table;
wherein the calculation of the ratio of primary colors is based on the following equations:
dR=abs(G−B);
dG=abs(B−R);
dB=abs(R−G);
dRGB=dR+dG+dB;
RGB=R+G+B;
Ratio=(dRGB/RGB)/2;
wherein ‘R’, ‘G’, ‘B’ are the red component, the green component and the blue component of the pixel value, respectively, and ‘abs’ is the function of absolute value.

13. The electronic device of claim 12, wherein the adjusted pixel value is calculated based on the following equations:
R′=R*ratio+W′(R)*(1−ratio);
G′=G*ratio+W′(G)*(1−ratio);
B′=B*ratio+W′(B)*(1−ratio);
wherein R′, G′, B′ are the red component, the green component and the blue component of the adjusted pixel value, respectively, and “W′( )” is a function of mapping the white component ‘w’ of the pixel value according to the lookup table to generate the white component of the adjusted pixel value, wherein the white component of the adjusted pixel value fits the second Gamma level.

14. The electronic device of claim 12, wherein the adjusted pixel value is calculated based on the following equations:
R′=R*ratio+W′(R)*{1−[K₁*(ratio)+K₂*ratio]};
G′=G*ratio+W′(G)*{1−[K₁*(ratio)+K₂*ratio]};
B′=B*ratio+W′(B)*{1−[K₁*(ratio)+K₂*ratio]};
wherein R′, G′, B′ are the red component, the green component and the blue component of the adjusted pixel value, respectively, K₁ and K₂ are constants, and “W′( )” is a function of mapping the white component ‘w’ of the pixel value according to the lookup table to generate the white component of the adjusted pixel value, wherein the white component of the adjusted pixel value fits the second Gamma level.

15. The electronic device of claim 14, wherein K₁ is −1 and K₂ is 2.

16. The electronic device of claim 9, wherein both the first Gamma level and the second Gamma level are Gamma 2.2.
